(19) United States
(12) Patent Application Publication
(10) Pub. No.: US 2019/0106091 A1
(43) Pub. Date: Apr. 11, 2019

(54) BRAKING FORCE CONTROL APPARATUS FOR VEHICLE

(71) Applicant: TOYOTA JIDOSHA KABUSHIKI KAISHA, Toyota-shi (JP)

(72) Inventor: Hidehisa KATO, Sunto-gun (JP)

(73) Assignee: TOYOTA JIDOSHA KABUSHIKI KAISHA, Toyota-shi (JP)

(21) Appl. No.: 16/151,514

(22) Filed: Oct. 4, 2018

(30) Foreign Application Priority Data
Oct. 6, 2017 (JP) 2017-196303

(51) Int. Cl. B60T 8/28; B60T 8/172; B60T 8/176; B60K 28/16; B60T 17/22; B60T 13/74; B60T 8/26

(52) U.S. Cl. CPC B60T 8/28; B60T 8/172; B60T 8/176; B60T 11/34; B60T 17/221; B60T 13/745; B60T 8/266; B60K 28/16

(57) ABSTRACT

A braking force control apparatus is provided which has a first system including a first upstream braking actuator and a first downstream braking actuator, a second system including a second upstream braking actuator and a second downstream braking actuator, and a control unit. When the downstream braking actuator is abnormal and the upstream pressure can be supplied to braking force generating devices, but a braking pressure of any one of the wheels cannot be normally controlled, the control unit select the pressure increasing side control mode out of the front wheel control modes as a first prescribed control mode, select the pressure decreasing side control mode out of the rear wheel control modes as a second prescribed control mode, and to control the first and second upstream pressures in the first and second prescribed control modes.

### CROSS-REFERENCE TO RELATED APPLICATION

The disclosure of Japanese Patent Application No. JP2017-196303 filed on Oct. 6, 2017 is incorporated by reference in its entirety.

### BACKGROUND

### 1. Technical Field

The present disclosure relates to a braking force control apparatus for a vehicle such as an automobile.

### 2. Description of the Related Art

For example, as described in Japanese Patent Application Laid-open Publication No. 2012-116300, a braking force control apparatus having a first system for controlling braking forces of left and right front wheels, a second system for controlling braking forces of left and right rear wheels, and a control unit for controlling the first and second systems are known. The first system includes a first upstream braking actuator including a master cylinder device and generating a first upstream pressure common to the left and right front wheels and a first downstream braking actuator that individually controls braking pressures supplied to braking force generating devices of the left and right front wheels using the first upstream pressure. Similarly, the second system includes a second upstream braking actuator including the master cylinder device and generating a second upstream pressure common to the left and right rear wheels and a second downstream braking actuator that individually controls braking pressures supplied to braking force generating devices of the left and right rear wheels using the second upstream pressure.

In a vehicle equipped with a braking force control apparatus in which the first and second systems each have an upstream braking actuator and a downstream braking actuator, anti-skid control is as well performed so that a braking slip of each wheel does not become excessive. In the anti-skid control, the braking pressure supplied to the braking force generating device of each wheel having a large braking slip is individually controlled by a pressure increasing-holding valve and pressure decreasing valve in the downstream braking actuator.

If an abnormality occurs in a pressure increasing-holding valve or a pressure decreasing valve of any of the wheels, a braking pressure of the relevant wheel cannot be normally controlled. In a conventional braking force control apparatus, for example, when an abnormality occurs in a pressure decreasing valve of any of the wheels and it becomes impossible to reduce a braking pressure of the relevant wheel, the anti-skid control is stopped. Therefore, it is impossible to prevent a braking slip of each wheel from becoming excessive in a situation where a braking operation amount of a driver is excessive.

Even if an abnormality occurs in the downstream braking actuator, when the abnormality is an abnormality that allows to supply the upstream pressure from the upstream braking actuator to the braking force generating devices of the respective wheels but cannot reduce the braking pressure of any of the wheels (referred to as “specific abnormality” as necessary), it is possible to reduce a possibility that a braking slip of a wheel becomes excessive by controlling the upstream pressure. Conventionally, no study has been made to reduce a possibility that a braking slip of a wheel becomes excessive by the control of the upstream pressure when a specific abnormality occurs in the downstream braking actuator. There is neither description nor suggestion in the above-mentioned publication.

### SUMMARY

The present disclosure provides a braking force control apparatus for a vehicle which is improved to reduce a possibility that a braking slip of a wheel becomes excessive by the control of an upstream pressure when a specific abnormality in which the upstream pressure can be supplied to braking force generating devices but a braking pressure of a wheel cannot be reduced occurs in a downstream braking actuator.

According to the present disclosure, a braking force control apparatus for a vehicle is provided which has a first system for controlling braking forces of left and right front wheels, a second system for controlling braking forces of left and right rear wheels, and a control unit for controlling the first and second systems; the first system includes a first upstream braking actuator including a master cylinder device and generating a first upstream pressure common to the left and right front wheels, and a first downstream braking actuator that individually controls braking pressures supplied to braking force generating devices of the left and right front wheels using the first upstream pressure; and the second system includes a second upstream braking actuator including the master cylinder device and generating a second upstream pressure common to the left and right rear wheels and a second downstream braking actuator that individually controls braking pressures supplied to braking force generating devices of the left and right rear wheels using the second upstream pressure, the control unit being configured to, when an anti-skid control starting condition is satisfied for any one of the wheels, control the first or second downstream braking actuator for the relevant wheel in control modes of a pressure increasing mode, a pressure holding mode and a pressure decreasing mode so that a degree of braking slip of the relevant wheel falls within a predetermined range until an anti-skid control ending condition is satisfied, and control the first and second downstream braking actuators in a non-control mode so that braking pressures of the wheels other than the relevant wheel become values corresponding to a braking operation amount of a driver.

The first and second upstream braking actuators are configured to control the first and second upstream pressures, respectively, in control modes of a pressure increasing mode, a pressure holding mode, a pressure decreasing mode and a non-control mode, and set the first and second upstream pressures to a pressure in the master cylinder device when the control mode is the non-control mode.

The control unit is configured, in selecting the control mode on a pressure increasing side, a priority of selection being set higher in the order of the pressure increasing mode, the pressure holding mode, the pressure decreasing mode and the non-control mode, and in selecting the control mode on a pressure decreasing side, the priority of selection being set higher in the order of the pressure decreasing mode, the pressure holding mode, the pressure increasing mode, and the non-control mode, to select a pressure increasing side control mode out of the control modes of the left and right front wheels as a first prescribed control mode, to select a pressure decreasing side mode out of the control modes of the left and right rear wheels as a second prescribed control mode, and to control the first and second upstream pressures in the first and second prescribed control modes, respectively when a specific abnormality in which the first and second upstream pressures can be supplied from the first and second upstream braking actuators, respectively, to the braking force generating devices of the corresponding wheels but a braking pressure supplied to the braking force generating device of any one of the wheels cannot be reduced occurs in the first and/or second downstream braking actuators.

According to the above configuration, when a specific abnormality occurs in the first and/or second downstream braking actuators, a pressure increasing side control mode is selected out of the control modes of the left and right front wheels as a first prescribed control mode; a pressure decreasing side control mode is selected out of the control modes of the left and right rear wheels as a second prescribed control mode; and the first and second upstream pressures are controlled in the first and second prescribed control modes, respectively.

Therefore, as compared to where, when a specific abnormality occurs in the first and/or second downstream braking actuators, the braking force generating devices of the wheels are connected with the master cylinder device without controlling the corresponding first and/or second downstream braking actuators, it is possible to reduce a possibility that the braking pressures become excessive and braking slips of the wheels become excessive in a situation where a braking operation amount of a driver is excessive.

Further, as compared to where the first and second prescribed control modes are set to the pressure decreasing side modes out of the control modes of the left and right front wheels and the left and right rear wheels, respectively, the braking force of the entire vehicle can be increased. Conversely, as compared to where the first and second prescribed control modes are set to the pressure increasing side modes out of the control modes of the left and right front wheels and the left and right rear wheels, respectively, the braking forces of the rear wheels and the entire vehicle can be decreased. Therefore, it is possible to reduce a possibility that the stability of the vehicle decreases due to excessive braking forces of the rear wheels and the entire vehicle while satisfying a braking request of the driver as much as possible.

In either selection of the control mode on the pressure increasing side and on the pressure decreasing side, when the two control modes to be selected are the same, the control modes is selected.

In another aspect of the present disclosure, the control unit is configured to select the pressure decreasing side mode out of the control modes of the left and right front wheels as the first prescribed control mode, to select the pressure decreasing side mode out of the control modes of the left and right rear wheels as the second prescribed control mode, and to control the first and second upstream pressures in the first and second prescribed control modes, respectively when a running state of the vehicle is unstable.

According to the above aspect, when a running state of the vehicle is unstable, the pressure decreasing side mode is selected out of the control modes of the left and right front wheels as the first prescribed control mode, and the pressure decreasing side mode is selected out of the control modes of the left and right rear wheels as the second prescribed control mode. Therefore, as compared to where the pressure increasing side modes are selected out of the control modes of the left and right front wheels and the right and left rear wheels as the first and second prescribed control modes, respectively, it is possible to reduce the braking forces of the front wheels and the rear wheels and to reduce a possibility of further deteriorating the running stability of the vehicle during turning.

Further, in another aspect of the present disclosure, the control unit is configured to select the pressure increasing side control mode out of the control modes of the left and right front wheels as the first prescribed control mode, to select the pressure increasing side control mode out of the control modes of the left and right rear wheels as the second prescribed control mode, and to control the first and second upstream pressures in the first and second prescribed control modes, respectively when a running state of the vehicle is stable and the vehicle is not turning.

According to the above aspect, the prescribed control mode of the first system is set to the pressure increasing side mode out of the control modes of the left and right front wheels, and the prescribed control mode of the second system is set to the pressure increasing side mode out of the control modes of the left and right rear wheels. Accordingly, as compared to where the prescribed control mode of the second system is set to the pressure decreasing side mode out of the control modes of the left and right rear wheels, for example, the braking force of the entire vehicle can be increased and a braking request of the driver can be effectively satisfied. Notably, since the vehicle is running stably without turning, even if the braking force of the entire vehicle is high, the stability of the vehicle does not substantially deteriorate.

Further, in another aspect of the present disclosure, the control unit is configured to select the pressure increasing side control mode out of the control modes of the left and right front wheels as the first prescribed control mode, to select the pressure decreasing side control mode out of the control modes of the left and right rear wheels as the second prescribed control mode, and to control the first and second upstream pressures in the first and second prescribed control modes, respectively when a running state of the vehicle is stable and the vehicle is turning.

According to the above aspect, the prescribed control mode of the first system is set to the pressure increasing side mode out of the control modes of the left and right front wheels, and the prescribed control mode of the second system is set to the pressure decreasing side mode out of the control modes of the left and right rear wheels. Therefore, it is possible to reduce the braking forces of the rear wheels and to reduce a possibility that a running stability of the vehicle while turning deteriorates as compared to where the prescribed control mode of the second system is set to the pressure increasing side mode out of the control modes of the left and right rear wheels.

Further, in another aspect of the present disclosure, a braking force control apparatus for a vehicle is provided which has a first system for controlling braking forces of left front wheel and right rear wheel, a second system for controlling braking forces of right front wheel and left rear wheel, and a control unit for controlling the first and second systems; the first system includes a first upstream braking actuator including a master cylinder device and generating a first upstream pressure common to the left front wheel and the right rear wheel, and a first downstream braking actuator that individually controls braking pressures supplied to braking force generating devices of the left front wheel and the right rear wheel using the first upstream pressure; and the second system includes a second upstream braking actuator including the master cylinder device and generating a second upstream pressure common to the right front wheel and the eft rear wheel and a second downstream braking actuator that individually controls braking pressures supplied to braking force generating devices of the right front wheel and the left rear wheel using the second upstream pressure, the control unit being configured to, when an anti-skid control start condition is satisfied for any one of the wheels, control the first or second downstream braking actuator for the relevant wheel in control modes of a pressure increasing mode, a pressure holding mode and a pressure decreasing mode so that a degree of braking slip of the relevant wheel falls within a predetermined range until an anti-skid control ending condition is satisfied, and control the first and second downstream braking actuators in a non-control mode so that braking pressures of the wheels other than the relevant wheel become values corresponding to a braking operation amount of a driver.

The first and second upstream braking actuators are configured to control the first and second upstream pressures, respectively, in control modes of a pressure increasing mode, a pressure holding mode, a pressure decreasing mode and a non-control mode, and set the first and second upstream pressures to a pressure in the master cylinder device when the control mode is the non-control mode.

The control unit is configured, in selecting the control mode on a pressure increasing side, a priority of selection being set higher in the order of the pressure increasing mode, the pressure holding mode, the pressure decreasing mode and the non-control mode, and in selecting the control mode on a pressure decreasing side, the priority of selection being set higher in the order of the pressure decreasing mode, the pressure holding mode, the pressure increasing mode, and the non-control mode, to select a pressure decreasing side control mode out of the control modes of the two wheels of the first system as a first prescribed control mode, to select a pressure decreasing side mode out of the control modes of the two wheels of the second system as a second prescribed control mode, and to control the first and second upstream pressures in the first and second prescribed control modes, respectively when a specific abnormality in which the first and second upstream pressures can be supplied from the first and second upstream braking actuators, respectively, to the braking force generating devices of the corresponding wheels but a braking pressure supplied to the braking force generating device of any one of the wheels cannot be reduced occurs in the first and/or second downstream braking actuators.

According to the above aspect, when the specific abnormality occurs in the first and/or second downstream braking actuator, a pressure decreasing side mode is selected out of the control modes of the two wheels of the first system as a first prescribed control mode, and a pressure decreasing side mode is selected out of the control modes of the two wheels of the second system as a second prescribed control mode. Furthermore, the first and second upstream pressures are controlled in the first and second prescribed control modes, respectively.

Therefore, as compared to where the pressure increasing side mode is selected for at least one of the control modes of the two wheels of the first system and the control modes of the two wheels of the second system, it is possible to reduce the braking force of the entire vehicle and to reduce a possibility that a braking slip becomes excessive due to an excessive braking force.

Further, in another aspect of the present disclosure, the control unit is configured to select the pressure increasing side control mode out of the control modes of the two wheels of the first system as the first prescribed control mode, to select the pressure increasing side control mode out of the control modes of the two wheels of the second system as the second prescribed control mode, and to control the first and second upstream pressures in the first and second prescribed control modes, respectively when a running state of the vehicle is stable and the control modes of the left and right rear wheels are not the pressure decreasing mode.

According to the above aspect, when a running state of the vehicle is stable and the control modes of the left and right rear wheels are not the pressure decreasing mode, the pressure increasing side mode is selected out of the control modes of the two wheels of the first system as a first prescribed control mode, and the pressure increasing side mode is selected out of the control modes of the two wheels of the second system as a second prescribed control mode. Therefore, as compared to where the upstream pressure is not controlled as described above, it is possible to increase the braking force of the entire vehicle and to effectively satisfy a braking request of the driver. Notably, since a running state of the vehicle is stable and the control modes of the left and right rear wheels are not the pressure decreasing mode, even if the braking forces of the wheels are high, the stability of the vehicle does not substantially deteriorate.

Further, in another aspect of the present disclosure, the control unit is configured to select the pressure decreasing side control mode out of the control modes of the two wheels of the first system as the first prescribed control mode, to select the pressure decreasing side control mode out of the control modes of the two wheels of the second system as the second prescribed control mode, and to control the first and second upstream pressures in the first and second prescribed control modes, respectively when a running state of the vehicle is stable but at least one of the control modes of the left and right rear wheels is the pressure decreasing mode.

According to the above aspect, as compared to where the pressure increasing side mode is selected out of the control modes of the two wheels for at least one of the first and second systems, the braking force of the vehicle can be reduced, so that it is possible to reduce a possibility that a running stability of the vehicle deteriorates due to an excessive braking force.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a first embodiment of a braking force apparatus for a vehicle according to the present disclosure that is configured as a braking force apparatus of front-rear two-system type.

FIG. 2 is a flowchart showing a control routine of upstream braking actuators in the first embodiment.

FIG. 3 is a flowchart showing a control routine of downstream braking actuators in the first embodiment.

FIG. 4 is a flowchart showing a control routine of upstream braking actuators in a second embodiment omitting a part of the control routine.

FIG. 5 is a schematic configuration diagram showing a third embodiment of a braking force apparatus for a vehicle according to the present disclosure that is configured as a braking force apparatus of X-piping two-system type.

FIG. 6 is a flowchart showing a control routine of upstream braking actuators in the fourth embodiment omitting a part of the control routine.

### DETAILED DESCRIPTION

The present disclosure will now be described in detail with reference to the accompanying drawings.

### First Embodiment

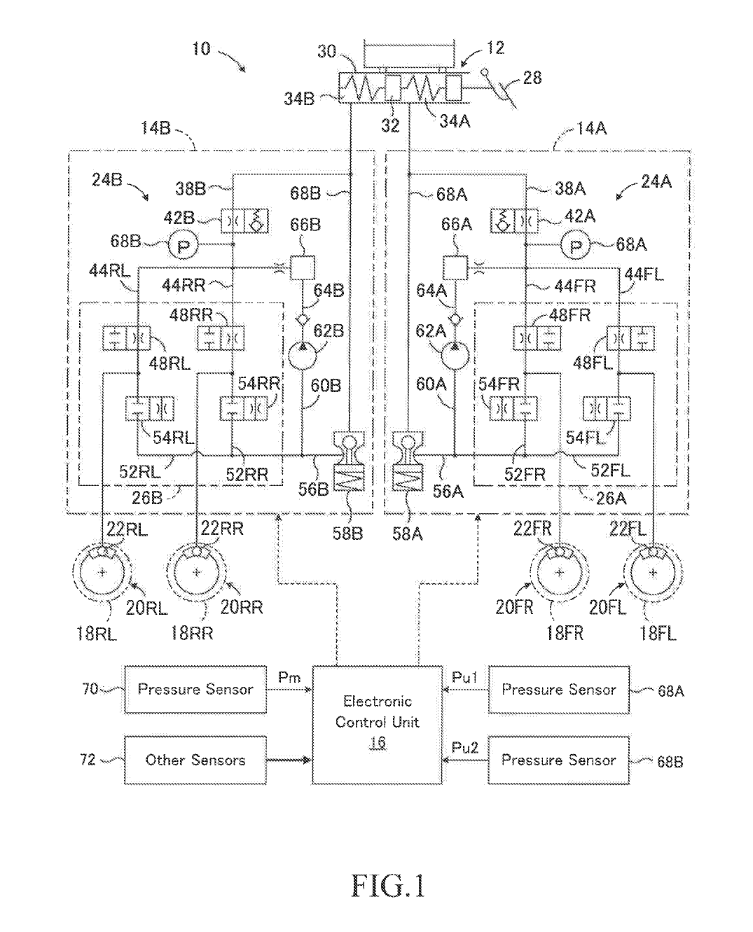

As shown in FIG. 1, the braking force control apparatus 10 of the first embodiment is configured as a braking force control apparatus of front-rear two-system type including a front wheel system and a rear wheel system. The braking force control apparatus 10 has a master cylinder device 12 driven by braking operation of a driver, a first system 14A serving as a front wheel system, a second system 14B serving as a rear wheel system, and an electronic control unit (ECU) 16 serving as a control device that controls these systems. Although the master cylinder device 12 is shown independently from the first system 14A and the second system 14B in FIG. 1, the first system 14A and the second system 14B include the master cylinder device 12. Notably, the illustration of springs and solenoids of each valve is omitted for the purpose of simplification.

Although not shown in detail in FIG. 1, braking force generating devices 20FL and 20FR are provided corresponding to left and right front wheels 18FL and 18FR, and braking force generating devices 20RL and 20RR are provided corresponding to left and right rear wheels 18RL and 18RR. The braking force generating devices 20FL to 20RR include wheel cylinders 22FL to 22RR, respectively, and convert pressures in the wheel cylinders that is, braking pressures Pwfl to Pwrr into braking forces to change pressing forces of brake pads against brake discs in accordance with the braking pressures, to thereby generate braking forces corresponding to the braking pressures. The braking force generating devices may be drum-type braking force generating devices.

The first system 14A includes a first upstream braking actuator 24A and a first downstream braking actuator 26A and the second system 14B includes a second upstream braking actuator 24B and a second downstream braking actuator 26B. As will be described in detail later, the upstream braking actuator 24A controls the first upstream pressure Pu1 and the downstream braking actuator 26A controls the braking pressures Pwfl and Pwfr of the left and right front wheels 18FL and 18FR using the upstream pressure Pu1. Similarly, the upstream braking actuator 24B controls the second upstream pressure Pu2 and the downstream braking actuator 26B controls the braking pressures Pwrl and Pwrr of the left and right rear wheels 18RL and 18RR using the upstream pressure Pu2.

The master cylinder device 12 has a master cylinder 30 that feeds brake oil in pressure in response to depression of a brake pedal 28 by a driver. The master cylinder 30 has a first master cylinder chamber 34A and a second master cylinder chamber 34B defined by a free piston 32, and the free piston 32 is urged to a predetermined position by compression coil springs provided on both sides thereof.

One ends of a brake hydraulic pressure control conduit 38A of the first system and a brake hydraulic pressure control conduit 38B of the second system are connected to the first master cylinder chamber 34A and the second master cylinder chamber 34B, respectively. The brake hydraulic pressure control conduits 38A and 38B connect the master cylinder chambers 34A and 34B to the upstream braking actuators 24A and 24B, respectively.

The brake hydraulic pressure control conduit 38A is provided with a first system communication control valve 42A, and in the illustrated embodiment, the communication control valve 42A is a normally open type linear solenoid valve. The communication control valve 42A opens when a driving current is not supplied to a solenoid not shown in FIG. 1, and closes when a driving current is supplied to the solenoid. In particular, when the communication control valve 42A is in the closed state, it maintains a differential pressure such that the pressure on the side opposite to the master cylinder 30 becomes higher than the pressure on the side of the master cylinder 30, and increases or decreases the differential pressure according to a voltage of the drive current.

In other words, when the differential pressure across the communication control valve 42A is lower than a command differential pressure determined by the voltage of the drive current to the solenoid, the communication control valve 42A maintains the closed state. Therefore, the communication control valve 42A prevents the oil as working liquid from flowing from the side opposite to the master cylinder 30 to the side of the master cylinder 30 through the communication control valve 42A, whereby preventing the pressure difference across the communication control valve 42A from decreasing. On the other hand, when the differential pressure across the communication control valve 42A exceeds the command differential pressure determined by the voltage of the drive current to the solenoid, the communication control valve 42A opens. Therefore, the communication control valve 42A permits the oil to flow from the side opposite to the master cylinder 30 to the side of the master cylinder 30 through the communication control valve 42A, whereby controlling the differential pressure across the communication control valve 42A to the command differential pressure.

One ends of a brake hydraulic pressure control conduit 44FL for the left front wheel and a brake hydraulic pressure control conduit 44FR for the right front wheel are connected to the other end of the brake hydraulic pressure control conduit 38A of the first system 14A. The wheel cylinders 22FL and 22FR are connected to the other ends of the brake hydraulic pressure control conduits 44FL and 44FR, respectively. Normally open type electromagnetic on-off valves 48FL and 48FR are provided in the brake hydraulic pressure control conduits 44FL and 44FR, respectively.

One end of an oil discharge conduit 52FL is connected to the brake hydraulic pressure control conduit 44FL between the electromagnetic on-off valve 48FL and the wheel cylinder 22FL. One end of an oil discharge conduit 52FR is connected to the brake hydraulic pressure control conduit 44FR between the electromagnetic on-off valve 48FR and the wheel cylinder 22FR. Normally closed electromagnetic on-off valves 54FL and 54FR are provided in the oil discharge conduits 52FL and 52FR, respectively, and the other ends of the oil discharge conduits 52FL and 52FR are connected to a reservoir 58A of the first system 14A that stores oil by a connection conduit 56A.

As can be understood from the above description, the electromagnetic on-off valves 48FL and 48FR are pressure increasing-holding valves for increasing or holding the pressures in the wheel cylinders 22FL and 22FR, respectively, and the electromagnetic on-off valves 54FL and 54FR are pressure decreasing valves for decreasing the pressures in the wheel cylinders 22FL and 22FR, respectively. Accordingly, the electromagnetic on-off valves 48FL and 54FL cooperate with each other to function as control valves for increasing and decreasing the pressure in the wheel cylinder 22FL of the left front wheel 18FL, and the electromagnetic on-off valves 48FR and 54FR cooperate with each other to function as control valves for increasing and decreasing the pressure in the wheel cylinder 22FR of the right front wheel 18FR.

The connection conduit 56A is connected to the suction side of a pump 62A by a connection conduit 60A. The discharge side of the pump 62A is connected to the other end of the brake hydraulic pressure control conduit 38A by a connection conduit 64A. The connecting conduit 64A is provided with an accumulator 66A for storing high pressure oil, but the accumulator may be omitted. A pressure sensor 68A is provided in the brake hydraulic pressure control conduit 38A between the connecting portion of the connection conduit 64A and the brake hydraulic pressure control conduit 38A and the communication control valve 42A. The sensor detects a pressure in the conduit as a first upstream pressure Pu1.

Similarly, a second system communication control valve 42B is provided in the brake hydraulic pressure control conduit 38B. In the illustrated embodiment, the communication control valve 42B is also a normally open type linear solenoid valve and operates in the same manner as the communication control valve 42A. Therefore, by controlling a voltage of a drive current supplied to a solenoid not shown in FIG. 1, the oil can be prevented from flowing from the side of the wheel cylinders 24RL and 24RR to the side of the master cylinder 30 via the communication control valve 42B, and the differential pressure across the communication control valve 42B can be controlled to a command differential pressure.

One ends of a brake hydraulic pressure control conduit 44RL for the left rear wheel and a brake hydraulic pressure control conduit 44RR for the right rear wheel are connected to the other end of the brake hydraulic pressure control conduit 38B of the second system 14B. The wheel cylinders 22RL and 22RR are connected to the other ends of the brake hydraulic pressure control conduits 44RL and 44RR, respectively. Normally open type electromagnetic on-off valves 48RL and 48RR are provided in the brake hydraulic pressure control conduits 44RL and 44RR, respectively.

One end of an oil discharge conduit 52RL is connected to the brake hydraulic pressure control conduit 44RL between the electromagnetic on-off valve 48RL and the wheel cylinder 22RL. One end of an oil discharge conduit 52RR is connected to the brake hydraulic pressure control conduit 44RR between the electromagnetic on-off valve 48RR and the wheel cylinder 22RR. Normally closed electromagnetic on-off valves 54RL and 54RR are provided in the oil discharge conduits 52RL and 52RR, respectively, and the other ends of the oil discharge conduits 52RL and 52RR are connected to a reservoir 58b of the second system 14B that stores oil by a connection conduit 56B.

As can be understood from the above description, the electromagnetic on-off valves 48RL and 48RR are pressure increasing-holding valves for increasing or holding the pressures in the wheel cylinders 22RL and 22RR, respectively, and the electromagnetic on-off valves 54RL and 54RR are pressure decreasing valves for decreasing the pressures in the wheel cylinders 22RL and 22RR, respectively. Accordingly, the electromagnetic on-off valves 48RL and 54 RL cooperate with each other to function as control valves for increasing and decreasing the pressure in the wheel cylinder 22RL of the left rear wheel 18RL, and the electromagnetic on-off valves 48RR and 54RR cooperate with each other to function as control valves for increasing and decreasing the pressure in the wheel cylinder 22RR of the right rear wheel 18RR.

The connection conduit 56B is connected to the suction side of a pump 62B by a connection conduit 60B. The discharge side of the pump 62B is connected to the other end of the brake hydraulic pressure control conduit 38B by a connection conduit 64B. The connecting conduit 64B is provided with an accumulator 66B for storing high pressure oil, but the accumulator may be omitted. A pressure sensor 68B is provided in the brake hydraulic pressure control conduit 38B between the connecting portion of the connection conduit 64B and the brake hydraulic pressure control conduit 38B and the communication control valve 42B. The sensor detects a pressure in the conduit as a second upstream pressure Pu2. Notably, the pumps 62A and 62B are electric pumps driven by a common electric motor or respective electric motors (not shown in FIG. 1).

The reservoirs 58A, 58B are connected to the brake hydraulic pressure control conduits 38A, 38B between the master cylinder 30 and the communication control valves 42A, 42B by connecting conduits 68A, 68B, respectively. Accordingly, the reservoirs 58A, 58B allow the flow of oil between the master cylinder chambers 34A, 341B and the reservoirs 58A, 58B, respectively, when the communication control valves 42A, 42B are in the closed state. A valve body of a check valve is integrally fixed to each of free pistons of the reservoirs 58A, 58B, and each check valve prevents an amount of oil in the reservoirs 58A, 58B from exceeding a reference value.

As shown in FIG. 1, the first downstream braking actuator 26A is composed of electromagnetic on-off valves 48FL, 48FR and electromagnetic on-off valves 54FL, 54FR. Similarly, the second downstream braking actuator 26B is composed of electromagnetic on-off valves 48RL, 48RR and electromagnetic on-off valves 54RL, 54RR. The first upstream braking actuator 24A is composed of a portion of the first system 14A excluding the first downstream braking actuator 26A and the master cylinder device 12. Similarly, the second upstream braking actuator 24B is composed of a portion of the second system 14B excluding the second downstream braking actuator 26B and the master cylinder device 12.

The master cylinder 30 is provided with a pressure sensor 70 for detecting a master cylinder pressure Pm, and a signal indicating the master cylinder pressure Pm detected by the pressure sensor 70 is input to the electronic control unit 16. Signals indicating the pressures Pu1 and Pu2 detected by the pressure sensors 68A and 68B, respectively, are also input to the electronic control unit 16. Further, signals indicating various parameters relating to a driving situation of the vehicle, such as a steering angle θ and a vehicle speed V, are also input from the other sensors 72 to the electronic control unit 16. The master cylinder pressure Pm is a value indicating a braking operation amount of a driver, but a depression force Fp applied to a brake pedal by the driver may be detected by a depression force sensor as a braking operation amount of the driver.

The communication control valves 42A and 42B, the on-off valves 48FL to 48RR, the on-off valves 54FL to 54RR, and the electric motors for driving the pumps 62A and 62B are controlled by the electronic control unit 16. In the normal state, the electronic control unit 16 controls the braking pressures of the respective wheels based on the master cylinder pressure Pm, whereby the braking force of each wheel is controlled in accordance with a depression operation amount of the brake pedal 28, that is, in accordance with a braking operation amount of the driver. Further, as will be described in detail later, the electronic control unit 16 controls the braking force of each wheel, as necessary, in accordance with the travelling situation of the vehicle.

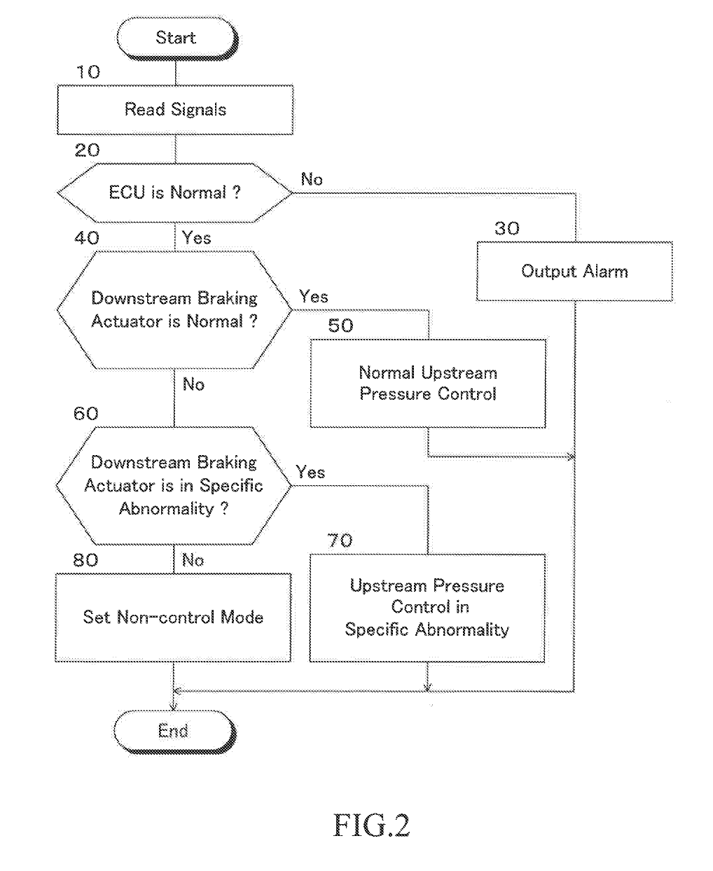

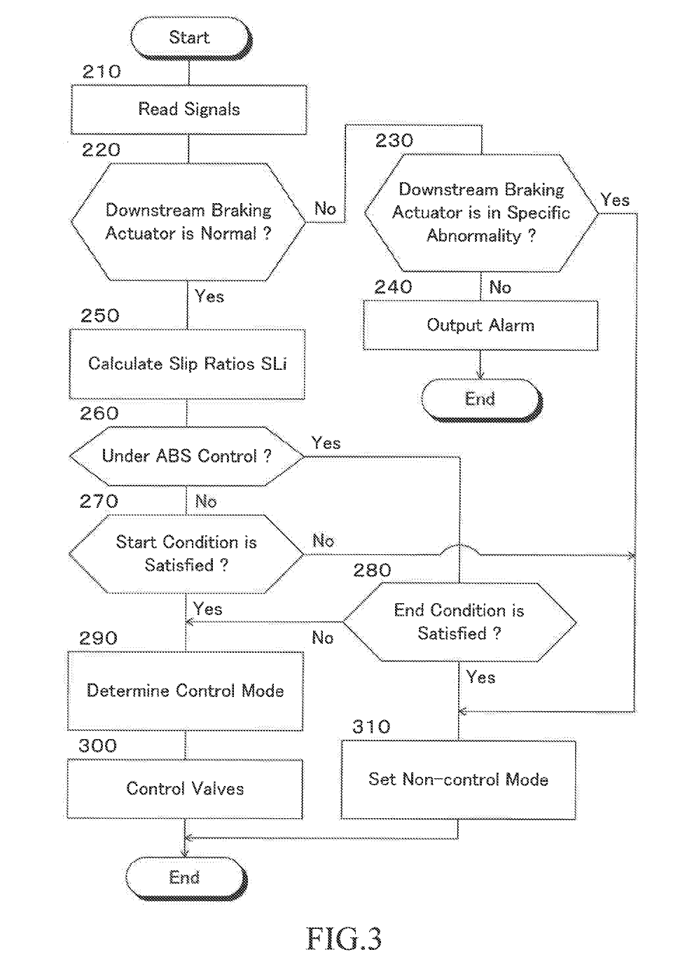

The electronic control unit 16 may be a microcomputer having, for example, a CPU, a ROM, a RAM, and an input/output port unit, which are connected to each other by a bi-directional common bus. The ROM stores a control program of the upstream braking actuators 24A and 24B corresponding to the flowchart shown in FIG. 2 and a control program of the downstream braking actuators 26A and 26B corresponding to the flowchart shown in FIG. 3. As will be described in detail later, the CPU controls the upstream braking actuators 24A and 24B according to the control program of the upstream braking actuators and controls the downstream braking actuators 26A and 26B according to the control program of the downstream braking actuators.

When the upstream braking actuators 24A and 24B and the downstream braking actuators 26A and 26B are normal, the communication control valves 42A and 42B are dosed and the pumps 62A and 62B are driven. When the pumps 62A and 62B are driven, the oil in the reservoirs 58A and 58B is pumped up by the pumps. Accordingly, the pressures pumped up by the pump 62A are supplied to the wheel cylinders 22FL and 22FR, and the pressures pumped up by the pump 62B are supplied to the wheel cylinders 22RL and 22RR.

During a normal period where it is not necessary to individually control the braking pressures of the respective wheels, the on-off valves of the downstream braking actuators 26A and 26B are maintained in the positions shown in FIG. 1. By controlling the communication control valves 42A and 42B, the upstream pressures Pu1 and Pu2 are controlled to be higher than the master cylinder pressure Pm and to vary according to the master cylinder pressure. Therefore, the pressures in the wheel cylinders 22FL and 22FR are controlled to the upstream pressure Pu1, and the pressures in the wheel cylinders 22RL and 22RR are controlled to the upstream pressure Pu2.

On the other hand, when it is necessary to individually control the braking pressures of the respective wheels, the on-off valves 48FL to 48RR and the on-off valves 54FL to 54RR are controlled. The pressures in the wheel cylinders are increased (pressure increasing mode) when the on-off valves 48FL to 48RR and the on-off valves 54FL to 54RR are in the non-control positions shown in FIG. 1. The pressures in the wheel cylinders are held (pressure holding mode) when the on-off valves 48FL to 48RR are switched to the closed positions and the on-off valves 54FL to 54RR are in the non-control positions shown in FIG. 1. Further, the pressures in the wheel cylinders are decreased (pressure decreasing mode) when the on-off valves 48FL to 48RR are switched to the closed positions and the on-off valves 54FL to 54RR are switched to the open positions.

In particular, in the first embodiment, control of the braking forces by an antiskid control (ABS control), that is, control of the braking forces by the pressure decreasing mode, the pressure holding mode, the pressure increasing mode and the non-control mode are performed by the control program of the downstream braking actuators 26A and 26B. Further, when it is impossible to reduce a braking pressure as in the case where the pressure decreasing valve of any one of the wheels remains closed and cannot be opened, it is determined that the downstream braking actuator 14 is in the specific abnormality. In a braking force control apparatus in which a braking pressure is reduced by suction of an oil pump, even when the oil pump or the electric motor for driving the oil pump malfunctions, it is also determined that the downstream braking actuators 26A and/or 26B are in the specific abnormality.

When the downstream braking actuators 26A and/or 26B are in the specific abnormality, the control program of the upstream braking actuators 24A and 24B controls the first and/or second upstream pressures Pu1 and/or Pu2 in the manner for the situation where the downstream braking actuators are in the specific abnormality. That is, prescribed control modes of the first system 14A and/or the second system 14B are determined according to the following equations (1), and the upstream pressures Pu1 and/or Pu2 are controlled in the first and/or second prescribed control modes, respectively. In the following equations (1), IN means selecting the control mode on the pressure increasing side out of the control modes of the two wheels in parenthesis, and DE means selecting the control mode on the pressure decreasing side out of the control modes of the two wheels in parenthesis.

Prescribed control mode of the first system=IN(left front wheel, right front wheel)

Prescribed control mode of the second system=DE(left rear wheel, right rear wheel) (1)

In selecting the control mode on the pressure increasing side, the priority of selection is set higher in the order of the pressure increasing mode, the pressure holding mode, the pressure decreasing mode and the non-control mode, and in the selection of the control mode on the pressure decreasing side, the priority of selection is set higher in the order of the pressure decreasing mode, the pressure holding mode, the pressure increasing mode and the non-control mode. When the two control modes to be selected are the same, the control mode is selected. The meanings of the aforementioned IN and DE and the priority of selection are the same in the other embodiment to be described later.

It is to be noted that in the first and other embodiments to be described later, when the downstream braking actuators 26A and/or 26B are abnormal other than in a specific abnormality, each control valve and each on-off valve are set to a position where the corresponding solenoid is not energized with a driving current, that is, the non-control position shown in FIG. 1. However, depending on the abnormality situation of the downstream braking actuators 26A and/or 26B, there may be a case where a control valve or an on-off valve does not assume the non-control position shown in FIG. 1.

### <Control of Upstream Braking Actuators 24A and 24B>

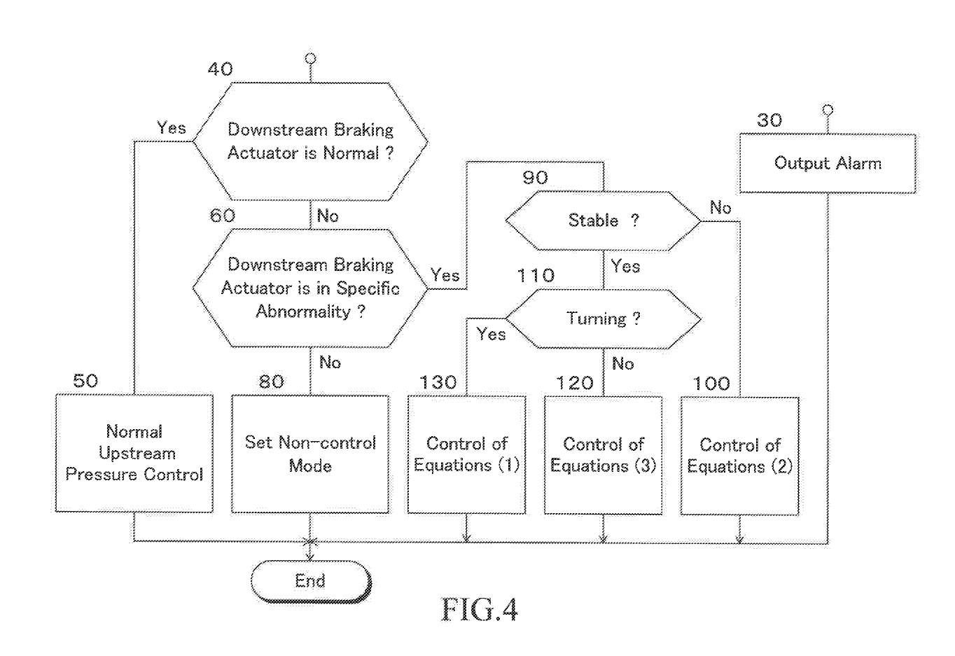

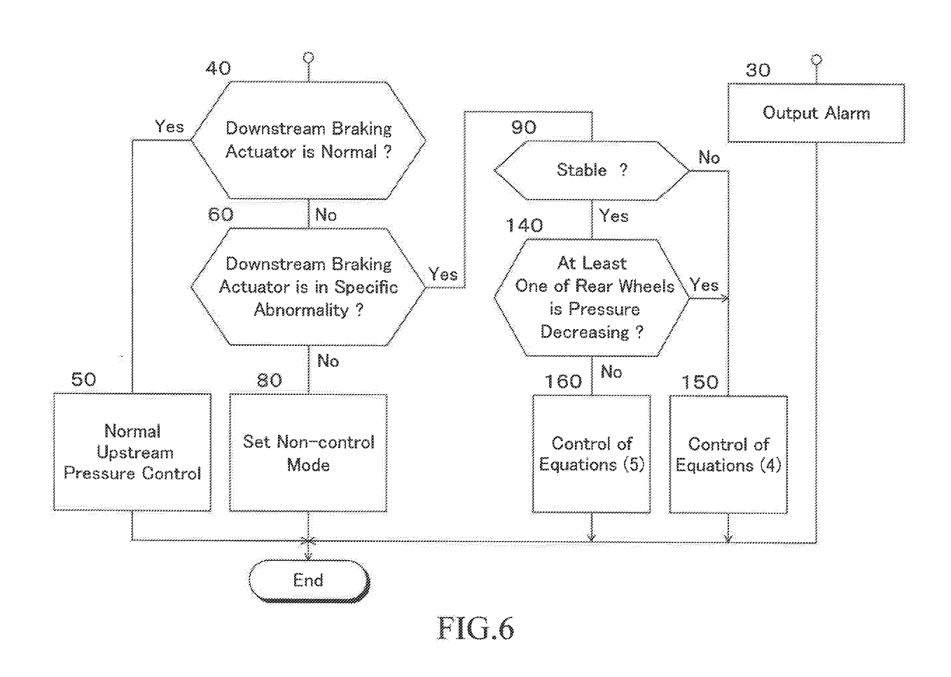

Next, the control routine of the upstream braking actuators 24A and 24B in the first embodiment will be described with reference to the flowchart shown in FIG. 2. The control according to the flowchart shown in FIG. 2 is repeatedly executed at predetermined time intervals alternately for the upstream braking actuators 24A and 24B when an ignition switch (not shown) is ON. In the following description, the control of the upstream braking actuators according to the flowchart shown in FIG. 2 is simply referred to as “upstream pressure control”. This also applies to the control of the upstream braking actuators according to the flowcharts shown in FIGS. 4 and 6 to be described later.

First, in step 10, a signal indicating a master cylinder pressure Pm detected by the pressure sensor 70 and the like are read. In step 20, it is determined whether or not the electronic control unit 16 is normal. When an affirmative determination is made, the upstream pressure control proceeds to step 40, and when a negative determination is made, the upstream pressure control proceeds to step 30.

In step 30, an alarm indicating that the electronic control unit 16 is abnormal is output by actuating an alarm device not shown in FIG. 1.

In step 40, it is determined whether or not it is determined that the downstream braking actuators 26A and 26B are normal in step 220 of the control routine of the downstream braking actuators 26A and 26B, which will be described later. When a negative determination is made, the upstream pressure control proceeds to step 60, and when an affirmative determination is made, the upstream pressure control proceeds to step 50. For example, when the pressure increasing—holding valve of one of the wheels remains closed and cannot be opened or the pressure decreasing valve of one of the wheels remains opened and cannot be closed, it is determined that the downstream braking actuators 26A or 26B is not normal (in abnormality other than in the specific abnormality).

In step 50, normal controls of the upstream pressures Pu1 and Pu2 are performed. For example, the target upstream pressures Pu1t and Pu2t are calculated based on the master cylinder pressure Pm, or the target upstream pressures Pu1t and Pu2t are calculated based on the target deceleration of the vehicle by travel control such as inter-vehicle distance control. Furthermore, the communication control valves 42A and 42B are controlled so that the upstream pressures Pu1 and Pu2 become the target upstream pressures Pu1t and Pu2t respectively.

In step 60, it is determined whether or not the downstream braking actuator 26A or 26B is determined to be in a specific abnormality in step 230 of the control routine of the downstream braking actuators 26A and 26B described later. When a negative determination is made, the upstream pressure control proceeds to step 80, and when an affirmative determination is made, the upstream pressure control proceeds to step 70.

In step 70, the control of the upstream pressures Pu1t and/or Pu2t when the downstream braking actuators 26A and/or 26B are in a specific abnormality are performed in accordance with the pressure increasing mode, the pressure holding mode, the pressure decreasing mode or the non-control mode set in the control of the downstream braking actuator 26A and 26B, which will be described later. That is, according to the above equations (1), the prescribed control mode of the first system 14A is set to the pressure increasing side mode among the control modes of the left and right front wheels and the prescribed control mode of the second system 14B is set to the pressure decreasing side of the control mode of the left and right rear wheels. Furthermore, the first and second upstream pressures Pu1 and Pu2 are controlled in respective prescribed control modes. An alarm indicating that the downstream braking actuators 26A and/or 26B are in the specific abnormality may be output by operating the alarm device not shown in FIG. 1.

In step 80, no control currents are supplied to the communication control valves 42A and 42B and the electric motors driving the pumps, so that the upstream braking actuators 24A and 24B are controlled in the non-control mode. That is, the communication control valves 42A and 428 are opened and the pumps 62A and 62B are not driven. Notably, an alarm indicating that the downstream braking actuators 42A and 42B are abnormal other than in the specific abnormality may be output by actuating an alarm device not shown in FIG. 1.

### <Control of Downstream Braking Actuators 26A and 26B>

Next, the control routine of the downstream braking actuators 26A and 26B in the first embodiment will be described with reference to the flowchart shown in FIG. 3. The control according to the flowchart shown in FIG. 3 is repeatedly executed in the order of the left front wheel 18FL, the right front wheel 18FR, the left rear wheel 18RL and the right rear and the wheel 18RR, for example, when the ignition switch (not shown) is ON. In the following description, the control of the downstream braking actuator according to the flowchart shown in FIG. 3 is simply referred to as “downstream control”.

In step 210, signals indicating the wheel speeds Vwfl, Vwfr, Vwrl and Vwrr of the left front wheel 18FL, the right front wheel 18FR, the left rear wheel 18RL, and the right rear wheel 1RR detected by the wheel speed sensors among the other sensors 72 are read.

In step 220, it is determined whether or not the downstream braking actuators 26A and 26B are normal, that is, whether or not it is possible to normally open and close the pressure increasing-holding valves 48FL to 48RR and the pressure decreasing valves 54FL to 54RR of all the wheels. When an affirmative determination is made, the downstream control proceeds to step 250, and when a negative determination is made, the downstream control proceeds to step 230.

In step 230, it is determined whether or not the downstream braking actuators 26A and/or 26B are in the specific abnormality. When an affirmative determination is made, the downstream control proceeds to step 310, and when a negative determination is made, that is, when the downstream braking actuators 26A and/or 26B are abnormal but not in the specific abnormality, the downstream control proceeds to step 240.

In step 240, an alarm indicating that the downstream braking actuators 26A and/or 26B are abnormal but not in the specific abnormality is output by being activated by an alarm device not shown in FIG. 1, and thereafter, the downstream control ends once. Since the pressure increasing-holding valves 48FL to 48RR and the pressure decreasing valves 54FL to 54RR are not controlled, in principle, the pressure increasing-holding valves 48FL to 48RR of all the wheels are set to the open positions and the pressure decreasing valves 54FL to 54RR are set to the closed positions.

In step 250, an estimated vehicle speed Vb is calculated based on the wheel speeds Vwi (i=fl, fr, rl and rr) in a manner known in the art. Further, the braking slip rate SLi (i=fl, fr, rl or rr) of the wheel is calculated based on the estimated vehicle speed Vb and the wheel speeds Vwi.

In step 260, a determination is made as to whether or not braking force control by the anti-skid control is being performed for the relevant wheel. When an affirmative determination is made, the downstream control proceeds to step 280, and when a negative determination is made, the downstream control proceeds to step 270.

In step 270, a determination is made as to whether or not the condition for starting the control of the braking force by the anti-skid control is satisfied for the relevant wheel. For example, it is determined whether the estimated vehicle speed Vb is equal to or greater than a control start reference value Vbs (a positive constant) and the braking slip rate SLi of the wheel is equal to or greater than a reference value SLo (a positive constant). When a negative determination is made, the downstream control proceeds to step 310, and when an affirmative determination is made, the downstream control proceeds to step 290.

In step 280, it is determined whether or not the condition for ending the control of the braking force by the anti-skid control is satisfied for the relevant wheel. For example, when a vehicle speed V is equal to or lower than an ending reference value or a master cylinder pressure Pm is equal to or lower than an ending reference value, it may be determined that the ending condition is satisfied. When an affirmative determination is made, the downstream control proceeds to step 310, and when a negative determination is made, the downstream control proceeds to step 290.

In step 290, based on the braking slip rate SLi of the wheel, a determination is made in a manner known in the art as to whether the control mode for bringing the braking slip ratio to a value within the predetermined range is the pressure increasing mode, the pressure holding mode and the pressure decreasing mode.

In step 300, a target duty ratio Dti (i=fl, fr, rl or rr) of the pressure increasing-holding valve or the pressure decreasing valve of the wheel is calculated based on a deceleration Gxb of the vehicle calculated based on a longitudinal acceleration Gx of the relevant vehicle, the control mode and the braking slip rate SLi of the wheel. Further, the duty ratio of the pressure increasing-holding valve 48FL, 48FR, 48RL or 48RR or the pressure decreasing valve 54FL, 54FR, 54RL or 54RR of the relevant wheel is controlled according to the control mode and the target duty ratio Dti, so that the braking pressure of the wheel is controlled to an appropriate value. Note that braking force control by the anti-skid control may be performed in any manner known in the art.

In step 310, the downstream braking actuators 26A and 26B are controlled in the uncontrolled mode. That is, the pressure increasing-holding valve 48FL, 48FR, 48RL or 48RR of the relevant wheel is controlled to the open position, and the pressure decreasing valve 54FL, 54FR, 54RL or 54RR is controlled to the closed position.

As understood from the above description, when the downstream braking actuators 26A and 26B are normal, the control mode of the braking force by the anti-skid control is determined to one of the pressure increasing mode, the holding mode, the pressure decreasing mode, and the non-control mode depending on a state of the braking slip of each wheel. Further, the pressure increasing-holding valves 48FL to 48RR and the pressure decreasing valves 54FL to 54RR are controlled in the determined control mode. On the other hand, when the downstream brake actuators 26A and/or 26B are in the specific abnormality, the pressure increasing-holding valves 48FL to 48RR and the pressure decreasing valves 54FL to 54RR are controlled in the non-control mode.

Therefore, when the start condition of the anti-skid control is satisfied for any of the wheels, the braking pressure of the relevant wheel is controlled in the control modes of the pressure increasing mode, the pressure holding mode, and the pressure decreasing mode so that the degree of braking slip of the wheel is within a predetermined range until the ending condition of the anti-skid control is satisfied. Further, the downstream braking actuator is controlled in the non-control mode so that braking pressures of the wheels other than the relevant wheel become values corresponding to a braking operation amount of the driver.

### Operation of First Embodiment

Next, the operation of the braking force control apparatus 10 according to the first embodiment will be described with respect to various cases.

### <When the Downstream Brake Actuators 26A and 26B are Normal>

In step 40, an affirmative determination is made, and in step 50, the communication control valves 42A and 42B are controlled so that the upstream pressures Pu1 and Pu2 become the target upstream pressures Pu1t and Pu2t, respectively.

<When the Downstream Brake Actuators 26A and/or 26B are in a Specific Abnormality>

In steps 40 and 60, a negative determination and an affirmative determination are made, respectively. In step 70, the prescribed control modes of the upstream braking actuators 24A and 24B are determined according to equations (1) and the first and second upstream pressures Pu1 and Pu2 are controlled in the determined prescribed control modes. Therefore, the prescribed control mode of the upstream braking actuator 24A is set to the pressure increasing side mode out of the control modes of the left and right front wheels, and the prescribed control mode of the upstream braking actuator 24B is set to the pressure decreasing side mode out of the control modes of the left and right rear wheels.

Therefore, as compared to where the upstream braking actuators 14A and 14B are set to the non-control mode and the upstream pressures Pu1 and Pu2 are not controlled when the downstream braking actuators 26A and/or 26B are in the specific abnormality, it is possible to reduce a possibility that braking slips of the wheels become excessive in a situation where a driver's braking operation amount is excessive. Further, for example, the braking force of the entire vehicle can be increased as compared to where the prescribed control mode of the upstream braking actuator 24A is set to the pressure decreasing side mode out of the control modes of the left and right front wheels. Conversely, as compared to where the prescribed control mode of the upstream braking actuator 24B is set to the pressure increasing side mode out of the control modes of the left and right rear wheels, the braking forces of the rear wheels and the entire vehicle can be reduced. Therefore, it is possible to reduce a possibility that the stability of the vehicle decreases due to excessive braking forces of the rear wheels and the entire vehicle while satisfying a braking request of the driver as much as possible.

<When the Downstream Braking Actuators 26A and/or 26B are in the Other Abnormality>

Negative determinations are made in steps 40 and 60, and in step 80, the upstream brake actuators 24A and 24B are controlled in the non-control mode. Therefore, it is possible to connect the master cylinder 30 and the wheel cylinders 22FL to 22RR as much as possible, and to ensure a situation where the braking force of each wheel changes in accordance with a braking operation amount of the driver.

### Second Embodiment

FIG. 4 is a flowchart showing the control routine of the upstream braking actuators 24A and 24B in the second embodiment of the braking force control apparatus according to the present disclosure, omitting a part of the control routine. In FIG. 4, the same step numbers as those shown in FIG. 2 are assigned to the same steps as those shown in FIG. 2. This also applies to other embodiments to be described later. Notably, the downstream braking actuators 26A and 26B are controlled according to the flowchart shown in FIG. 3 as in the first embodiment. Therefore, the illustration and explanation of the flowchart of the control of the downstream braking actuator are omitted. These also apply to other embodiments to be described later.

In the second embodiment, steps 10 to 60 and step 80 are executed in the same manner as in the first embodiment. When an affirmative determination is made in step 60, that is, when it is determined that the downstream brake actuators 26A and/or 26B are in the specific abnormality, the upstream pressure control proceeds to step 90 instead of step 70.

In step 90, based on a deviation between a reference yaw rate of the vehicle and an actual yaw rate, for example, it is determined whether or not the vehicle is in a stable running state in a manner known in the art. When an affirmative determination is made, the upstream pressure control proceeds to step 110, and when a negative determination is made, the upstream pressure control proceeds to step 100.

In step 100, prescribed control modes of the first system 14A and the second system 14B are determined in accordance with the following equations (2), and the upstream pressures Pu1 and Pu2 are respectively controlled in the prescribed control modes of the first and second systems.

Prescribed control mode of the first system=DE(left front wheel, right front wheel)

Prescribed control mode of the second system=DE(left rear wheel, right rear wheel) (2)

In step 110, it is determined whether or not the vehicle is turning based on an actual yaw rate of the vehicle, for example. When an affirmative determination is made, the upstream pressure control proceeds to step 130, and when a negative determination is made, the upstream pressure control proceeds to step 120.

In step 120, prescribed control modes of the first system 14A and the second system 14B are determined in accordance with the following equations (3), and the upstream pressures Pu1 and Pu2 are respectively controlled in the prescribed control modes of the first and second systems.

Prescribed control mode of the first system=IN(left front wheel, right front wheel)

Prescribed control mode of the second system=IN(left rear wheel, right rear wheel) (3)

In step 130, prescribed control modes of the first system 14A and the second system 14B are determined according to the above equations (1). That is, the prescribed control mode of the first system is set to the pressure increasing side mode out of the control modes of the left and right front wheels, and the prescribed control mode of the second system is set to the pressure decreasing side mode out of the control modes of the left and right rear wheels. Furthermore, the first and second upstream pressures Pu1 and Pu2 are controlled in respective prescribed control modes.

### Operation of Second Embodiment

Next, the operation of the braking force control apparatus 10 according to the second embodiment will be described with respect to various cases which are in a situation where the downstream braking actuators 26A and/or 26B are in the specific abnormality. The operation of the case where the downstream braking actuators 26A and 26B are normal and the case where the downstream braking actuators 26A and/or 26B are in the other abnormality are the same as those of the first embodiment.

### <When the Vehicle is Stably Turning>

Affirmative determinations are made in steps 90 and 110. Therefore, in step 130, prescribed control modes of the first and second systems are determined according to the above equations (1), and the first and second upstream pressures Pu1 and Pu2 are respectively controlled in the corresponding prescribed control modes.

The prescribed control mode of the first system is set to the pressure increasing side mode out of the control modes of the left and right front wheels and the prescribed control mode of the second system is set to the pressure decreasing side mode out of the control modes of the left and right rear wheels. Therefore, as in the case where the downstream braking actuators 26A and/or 26B are in the specific abnormality in the first embodiment, as compared to where the upstream pressures Pu1 and Pu2 are not controlled, it is possible to reduce a possibility that braking slips of wheels become excessive in a situation where a braking operation amount of the driver is large. Further, it is possible to reduce a possibility that the stability of the vehicle decreases due to excessive braking forces of the rear wheels and the entire vehicle while satisfying a braking request of the driver as much as possible.

<When the Vehicle is Stably Traveling without Turning>

An affirmative determination is made in step 90, and a negative determination is made in step 110. Therefore, in step 120, prescribed control modes of the first and second systems are determined according to the above equations (3), and the first and second upstream pressures Pu1 and Pu2 are controlled in corresponding prescribed control modes.

The prescribed control mode of the first system is set to the pressure increasing side mode out of the control modes of the left and right front wheels and the prescribed control mode of the second system is set to the pressure increasing side mode out of the control modes of the left and right rear wheels. Therefore, the braking force of the entire vehicle can be increased and a braking request of the driver can be satisfied effectively as compared to where the prescribed control modes of the first and second systems are determined according to, for example, the above equations (1). Since the vehicle is traveling stably without turning, even if the braking force of the entire vehicle is high, the stability of the vehicle does not substantially deteriorate.

### <When the Vehicle is Running in an Unstable State>

A negative determination is made in step 90. Therefore, in step 100, prescribed control modes of the first and second systems are determined according to the above equations (2), and the first and second upstream pressures Pu1 and Pu2 are respectively controlled in the corresponding prescribed control modes.

The prescribed control mode of the first system is set to the pressure decreasing side mode among the control modes of the left and right front wheels and the prescribed control mode of the second system is set to the pressure decreasing side of the control mode of the left and right rear wheels. Accordingly, as compared to where the prescribed control modes of the first and second systems are determined in accordance with, for example, the above equations (1), the braking forces of the front wheels can be lowered, and it is possible to reduce the possibility that the running stability at the time of turning of the vehicle further decreases.

As can be understood from the above description, according to the second embodiment, in addition to the same operational effect as the first embodiment when the vehicle is stably turning, it is possible to optimally control the first and second upstream pressures Pu1 and Pu2 in accordance with a running condition of the vehicle.

### Third Embodiment

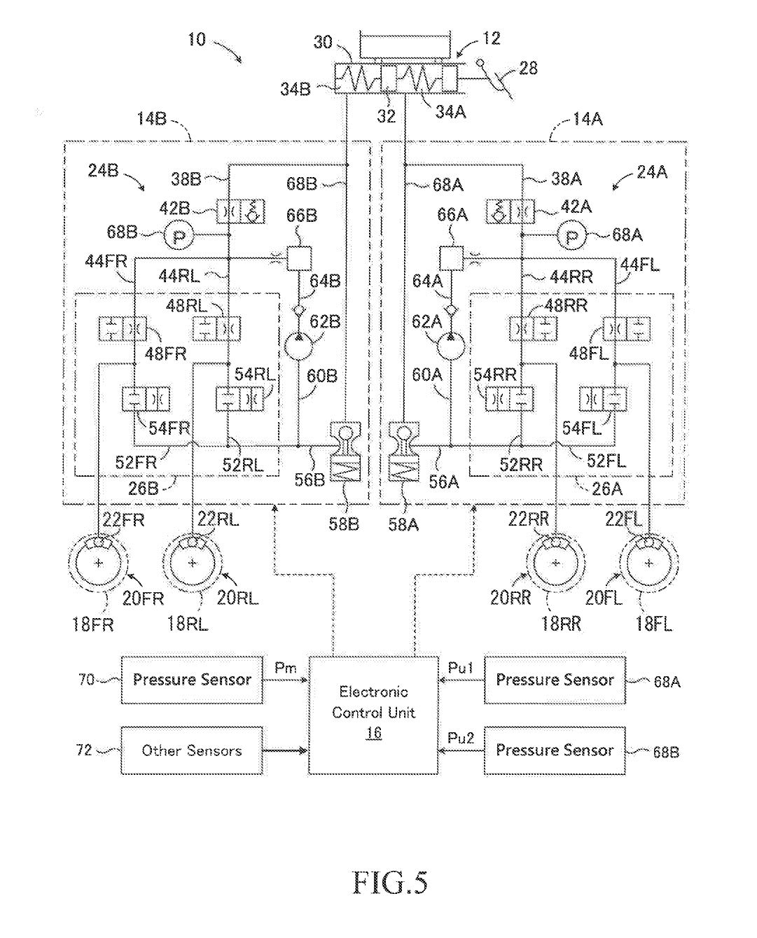

FIG. 5 is a schematic configuration diagram showing a third embodiment of the braking force control apparatus according to the present disclosure. In FIG. 5, the same reference numerals as those denoted in FIG. 1 are given to the same members as those shown in FIG. 1.

The braking force control apparatus 10 of the third embodiment and the fourth embodiment which will be described later is configured as a braking force control apparatus of X-piping two-system type including a left front wheel and right rear wheel system and a right front wheel and left rear wheel system. In the third and fourth embodiments, the left front wheel and right rear wheel system is the first system and the right front wheel and left rear wheel system is the second system, but the first and second systems may be reversed.

In the third embodiment, one end of the brake hydraulic pressure control conduit 44FR connected to the wheel cylinder 22FR of the right front wheel 18FR at the other end is connected to the other end of the brake hydraulic pressure control conduit 38B of the second system 14B. One end of a brake hydraulic pressure control conduit 44RR connected to the wheel cylinder 22RR of the right rear wheel 18RR at the other end is connected to the other end of the brake hydraulic pressure control conduit 38A of the first system 14A. The other points of the third embodiment are configured in the same manner as in the first embodiment. The above configuration is also the same in the fourth embodiment described later.

The control of the upstream braking actuators 24A and 24B in the third embodiment is executed in accordance with the flowchart shown in FIG. 2 as in the first embodiment. However, in step 50, prescribed control modes are determined according to the following equations (4), and the upstream pressures Pu1 and Pu2 are controlled in a prescribed control modes.

First prescribed control mode=DE(left front wheel, right rear wheel)

Second prescribed control mode=DE(right front wheel, left rear wheel) (4)

According to the third embodiment, the pressure decreasing side mode out of the control modes of the wheels of the first system is selected as the first prescribed control mode, and the mode on the pressure decreasing side out of the control modes of the wheels of the second system is selected as the second prescribed control mode. Therefore, the braking force of the entire vehicle can be reduced as compared to where, for example, the pressure increasing side mode of the control modes of the two wheels is selected for at least one of the first and second systems. Accordingly, it is possible to reduce a possibility that the stability of the vehicle is deteriorated due to a locking of a wheel.

### Fourth Embodiment

FIG. 6 is a flowchart showing a control routine of the upstream braking actuators 24A and 24B in the fourth embodiment of the braking force control apparatus according to the present disclosure, omitting a part of the control routine.

In the fourth embodiment, similarly to the second embodiment, steps 10 to 60 and step 80 are executed in the same manner as in the first embodiment. When an affirmative determination is made in step 60, that is, when it is determined that the downstream braking actuators 26A and/or 26B are in the specific abnormality, the upstream pressure control proceeds to step 90.

Step 90 is executed in the same manner as in the second embodiment. When a negative determination is made at step 90, that is, when it is determined that the vehicle is in an unstable traveling state, the upstream pressure control proceeds to step 150, and when an affirmative determination is made, the upstream pressure control proceeds to step 140.

In step 140, it is determined whether at least one of the control modes of the left and right rear wheels is the pressure decreasing mode. When a negative determination is made, the upstream pressure control proceeds to step 160, and when an affirmative determination is made, the upstream pressure control proceeds to step 150.

In step 150, prescribed control modes are determined according to the above equations (4), and the first and second upstream pressures Pu1 and Pu2 are respectively controlled in the corresponding prescribed control modes.

In step 160, prescribed control modes of the first and second systems are determined according to the following equations (5), and the first and second upstream pressures Pu1 and Pu2 are respectively controlled in the corresponding prescribed control modes.

First prescribed control mode=IN(left front wheel, right rear wheel)

Second prescribed control mode=IN(right front wheel, left rear wheel) (5)

According to the fourth embodiment, when the downstream braking actuators 26A and/or 26B are in the specific abnormality and the vehicle is in an unstable traveling state, the first and second prescribed control modes are determined in the same manner as in the third embodiment. That is, the pressure decreasing side mode out of the control modes of the wheels of the first system is selected as the first prescribed control mode, and the pressure decreasing side mode out of the control modes of the wheels of the second system is selected as the second prescribed control mode. Therefore, as in the third embodiment, as compared to where, for example, the pressure increasing side mode is selected out of the control modes of the two wheels for at least one of the first and second systems, the braking force of the entire vehicle can be reduced. Accordingly, it is possible to reduce a possibility that the stability of the vehicle is deteriorated due to a lock of a wheel.

Further, when the downstream braking actuators 26A and/or 26B are in the specific abnormality, the vehicle is in a stable running state and the control mode of the left and right rear wheels is the pressure increasing mode, the first and second prescribed control modes are determined according to the above equations (5). That is, the pressure increasing side mode out of the control modes of the wheels of the first system is selected as the first prescribed control mode, and the pressure increasing side mode out of the control modes of the wheels of the second system is selected as the second prescribed control mode. Therefore, in a situation where the stability of the vehicle is not likely to deteriorate, it is possible to ensure the necessary braking force of the entire vehicle and to effectively satisfy a braking request of the driver.

Further, even when the downstream braking actuators 26A and/or 26B are in the specific abnormality and the vehicle is in a stable running state, when at least one of the control modes of the left and right rear wheels is in the pressure decreasing mode, the prescribed control modes are determined according to the above equations (4) in step 150. Therefore, since the braking force of the vehicle can be prevented from becoming excessive, it is possible to reduce a possibility that the stability of the vehicle is deteriorated due to a lock of a wheel.

Although the present disclosure has been described in detail with reference to specific embodiments, it will be apparent to those skilled in the art that the present disclosure is not limited to the above-described embodiments, and various other embodiments are possible within the scope of the present disclosure.

For example, in the above-described embodiments, the upstream braking actuators 24A and 24B and the downstream braking actuators 26A and 26B are controlled by the electronic control unit 16. However, the upstream braking actuators 24A and 24B may be controlled by an electronic control unit for upstream pressure control and the downstream braking actuators 26A and 26B may be controlled by an electronic control unit for each wheel braking pressure control. In that case, the upstream pressure control according to the flowcharts shown in FIGS. 2, 4 and 6 may be performed by the electronic control unit for upstream pressure control, and the downstream control according to the flowchart shown in FIG. 3 may be executed by each wheel braking pressure control.

Further, in the above-described second embodiments, the determinations in steps 40, 60, 90 and 110 are made, and steps 70, 80, 100, 120 and 130 are executed according to the determination results. However, for example, the determination in step 110 may be omitted and when an affirmative determination is made in step 90, the upstream pressure control may proceed to step 130.

Further, in the above-described embodiments, the upstream braking actuator 24A includes a master cylinder device 12, a communication control valve 42A, and a pump 62A. Similarly, the upstream braking actuator 24B includes a master cylinder device 12, a communication control valve 42B, and a pump 62B. However, as described in, for example, Japanese Patent Application Laid-open Publication No. 2017-52305, the upstream braking actuators 24A and 24B may be an upstream braking actuator of a back pressure control type that can control the upstream pressures Pu1 and Pu2 by controlling the back pressure of the master cylinder 28.

What is claimed is:

1. A braking force control apparatus for a vehicle which has a first system for controlling braking forces of left and right front wheels, a second system for controlling braking forces of left and right rear wheels, and a control unit for controlling the first and second systems; the first system includes a first upstream braking actuator including a master cylinder device and generating a first upstream pressure common to the left and right front wheels, and a first downstream braking actuator that individually controls braking pressures supplied to braking force generating devices of the left and right front wheels using the first upstream pressure; and the second system includes a second upstream braking actuator including the master cylinder device and generating a second upstream pressure common to the left and right rear wheels and a second downstream braking actuator that individually controls braking pressures supplied to braking force generating devices of the left and right rear wheels using the second upstream pressure,
the control unit is configured to, when an anti-skid control starting condition is satisfied for any one of the wheels, control the first or second downstream braking actuator for the relevant wheel in control modes of a pressure increasing mode, a pressure holding mode and a pressure decreasing mode so that a degree of braking slip of the relevant wheel falls within a predetermined range until an anti-skid control ending condition is satisfied, and control the first and second downstream braking actuators in a non-control mode so that braking pressures of the wheels other than the relevant wheel become values corresponding to a braking operation amount of a driver, wherein
the first and second upstream braking actuators are configured to control the first and second upstream pressures, respectively, in control modes of a pressure increasing mode, a pressure holding mode, a pressure decreasing mode and a non-control mode, and set the first and second upstream pressures to a pressure in the master cylinder device when the control mode is the non-control mode, and
the control unit is configured, in selecting the control mode on a pressure increasing side, a priority of selection being set higher in the order of the pressure increasing mode, the pressure holding mode, the pressure decreasing mode and the non-control mode, and in selecting the control mode on a pressure decreasing side, the priority of selection being set higher in the order of the pressure decreasing mode, the pressure holding mode, the pressure increasing mode, and the non-control mode, to select a pressure increasing side control mode out of the control modes of the left and right front wheels as a first prescribed control mode, to select a pressure decreasing side mode out of the control modes of the left and right rear wheels as a second prescribed control mode, and to control the first and second upstream pressures in the first and second prescribed control modes, respectively when a specific abnormality in which the first and second upstream pressures can be supplied from the first and second upstream braking actuators, respectively, to the braking force generating devices of the corresponding wheels but a braking pressure supplied to the braking force generating device of any one of the wheels cannot be reduced occurs in the first and/or second downstream braking actuators.

2. The braking force control apparatus for a vehicle according to claim 1, wherein the control unit is configured to select the pressure decreasing side mode out of the control modes of the left and right front wheels as the first prescribed control mode, to select the pressure decreasing side mode out of the control modes of the left and right rear wheels as the second prescribed control mode, and to control the first and second upstream pressures in the first and second prescribed control modes, respectively when a running state of the vehicle is unstable.

3. The braking force control apparatus for a vehicle according to claim 1, wherein the control unit is configured to select the pressure increasing side control mode out of the control modes of the left and right front wheels as the first prescribed control mode, to select the pressure increasing side control mode out of the control modes of the left and right rear wheels as the second prescribed control mode, and to control the first and second upstream pressures in the first and second prescribed control modes, respectively when a running state of the vehicle is stable and the vehicle is not turning.

4. The braking force control apparatus for a vehicle according to claim 1, wherein the control unit is configured to select the pressure increasing side control mode out of the control modes of the left and right front wheels as the first prescribed control mode, to select the pressure decreasing side control mode out of the control modes of the left and right rear wheels as the second prescribed control mode, and to control the first and second upstream pressures in the first and second prescribed control modes, respectively when a running state of the vehicle is stable and the vehicle is turning.

5. A braking force control apparatus for a vehicle which has a first system for controlling braking forces of left front wheel and right rear wheel, a second system for controlling braking forces of right front wheel and left rear wheel, and a control unit for controlling the first and second systems; the first system includes a first upstream braking actuator including a master cylinder device and generating a first upstream pressure common to the left front wheel and the right rear wheel, and a first downstream braking actuator that individually controls braking pressures supplied to braking force generating devices of the left front wheel and the right rear wheel using the first upstream pressure; and the second system includes a second upstream braking actuator including the master cylinder device and generating a second upstream pressure common to the right front wheel and the left rear wheel and a second downstream braking actuator that individually controls braking pressures supplied to braking force generating devices of the right front wheel and the left rear wheel using the second upstream pressure,
the control unit is configured to, when an anti-skid control start condition is satisfied for any one of the wheels, control the first or second downstream braking actuator for the relevant wheel in control mode of a pressure increasing mode, a pressure holding mode and a pressure decreasing mode so that a degree of braking slip of the relevant wheel falls within a predetermined range until an anti-skid control ending condition is satisfied, and control the first and second downstream braking actuators in a non-control mode so that braking pressures of the wheels other than the relevant wheel become values corresponding to a braking operation amount of a driver, wherein
the first and second upstream braking actuators are configured to control the first and second upstream pressures, respectively, in control modes of a pressure increasing mode, a pressure holding mode, a pressure decreasing mode and a non-control mode, and set the first and second upstream pressures to a pressure in the master cylinder device when the control mode is the non-control mode, and
the control unit is configured, in selecting the control mode on a pressure increasing side, a priority of selection being set higher in the order of the pressure increasing mode, the pressure holding mode, the pressure decreasing mode and the non-control mode, and in selecting the control mode on a pressure decreasing side, the priority of selection being set higher in the order of the pressure decreasing mode, the pressure holding mode, the pressure increasing mode, and the non-control mode, to select a pressure decreasing side control mode out of the control modes of the two wheels of the first system as a first prescribed control mode, to select a pressure decreasing side mode out of the control modes of the two wheels of the second system as a second prescribed control mode, and to control the first and second upstream pressures in the first and second prescribed control modes, respectively when a specific abnormality in which the first and second upstream pressures can be supplied from the first and second upstream braking actuators, respectively, to the braking force generating devices of the corresponding wheels but a braking pressure supplied to the braking force generating device of any one of the wheels cannot be reduced occurs in the first and/or second downstream braking actuators.

6. The braking force control apparatus for a vehicle according to claim 5, wherein the control unit is configured to select the pressure increasing side control mode out of the control modes of the two wheels of the first system as the first prescribed control mode, to select the pressure increasing side control mode out of the control modes of the two wheels of the second system as the second prescribed control mode, and to control the first and second upstream pressures in the first and second prescribed control modes, respectively when a running state of the vehicle is stable and the control modes of the left and right rear wheels are not the pressure decreasing mode.

7. The braking force control apparatus for a vehicle according to claim 5, wherein the control unit is configured to select the pressure decreasing side control mode out of the control modes of the two wheels of the first system as the first prescribed control mode, to select the pressure decreasing side control mode out of the control modes of the two wheels of the second system as the second prescribed control mode, and to control the first and second upstream pressures in the first and second prescribed control modes, respectively when a running state of the vehicle is stable but at least one of the control modes of the left and right rear wheels is the pressure decreasing mode.
